(19) United States
(12) Patent Application Publication
(10) Pub. No.: US 2011/0194779 A1
(43) Pub. Date: Aug. 11, 2011

(54) APPARATUS AND METHOD FOR DETECTING MULTI-VIEW SPECIFIC OBJECT

(76) Inventors: Cheng ZHONG, Beijing (CN); Zhongchao Shi, Beijing (CN); Xun Yuan, Beijing (CN); Tong Liu, Beijing (CN); Tao Li, Beijing (CN); Gang Wang, Beijing (CN)

(21) Appl. No.: 12/968,603

(22) Filed: Dec. 15, 2010

(30) Foreign Application Priority Data
Feb. 8, 2010 (CN) 201010108579.5

(51) Int. Cl. G06K 9/68

(52) U.S. Cl. 382/218; 382/227

(57) ABSTRACT

Disclosed are an apparatus and a method for determining a multi-view specific object. The apparatus comprises an input device for inputting image data; and cascade classifiers formed of stage classifiers corresponding to a same detection angle, the stage classifiers corresponding to different features. Each cascade classifier is for calculating a degree of confidence of the image data of a specific object corresponding to the detection angle based on the aspect of the corresponding feature, and determining whether the image data belongs to the specific object based on the degree of confidence. A self-adaptive posture prediction device is disposed between two stage classifiers in each cascade classifier, and is used to determine whether the image data enters the cascade classifiers corresponding to the detection angles and located after the self-adaptive posture prediction device.

### BACKGROUND OF THE INVENTION

1. Field of the Invention

The present invention relates to an apparatus and a method for detecting a multi-view specific object, and more particularly relates to an apparatus and a method for detecting a multi-view specific object which can increase detection speed of the specific object on a condition where detection accuracy is not influenced.

2. Description of the Related Art

A rapid and accurate object detection algorithm is the basis of many applications in a field of image processing and video content analysis; the applications include, for example, human face detection and affect analysis, video conference control and analysis, a passerby protection system, etc. The AdaBoost human face detection algorithm may be effectively applied to frontal view human face recognition; there are many products based on this algorithm in the market, for example, a digital camera having a human face detection function, etc. However, with the rapid development of digital cameras and cell phones, a technique that can only carry out frontal view object detection cannot satisfy the demand; a rapid and accurate multi-view object detection technique is beginning to be watched around the world.

In U.S. Pat. No. 7,324,671 B2, an algorithm and an apparatus able to carry out human face detection are disclosed. In this patent, a human face detection system uses a sequence of strong classifiers of gradually increasing complexity to quickly discard non-human-face data at earlier stages (i.e. stages having lower complexity) in a multi-stage classifier structure. The multi-stage classifier structure has a pyramid-like architecture, and uses a coarse-to-fine and simple-to-complex scheme; as a result, by using relatively simple features (i.e. features employed at earlier stages in the multi-stage classifier structure), it is possible to discard a large amount of non-human-face data. By this way, a real-time multi-view human face detection system is achieved. However, the biggest problem of the algorithm is that the pyramid-like architecture includes a large amount of redundant information in the detection process; as a result, the detection speed and the detection accuracy are influenced.

In U.S. Pat. No. 7,457,432 B2, a method and an apparatus able to carry out specific object detection are disclosed. In this patent, HAAR features are employed as weak features. The Real AdaBoost algorithm is employed to train a strong classifier at each stage in a multi-stage classifier structure so as to further improve detection accuracy, and a LUT (i.e. look-up table) data structure is proposed to improve speed of feature selection. Here it should be noted that “strong classifier” and “weak feature” are well-known concepts in the art. However, one major drawback of this patent is that the method is able to be only applied to a specific object detection within a certain range of angles, i.e., frontal view human face detection is mainly carried out; as a result, its application is limited in some measure.

In International Publication WO No. 2008/151470 A1, a method and an apparatus able to carry out robust human face detection in a complicated background image are disclosed. In this patent, microstructure features having low calculation complexity and high redundancy are adopted to express human face features. The AdoBoost algorithm that is sensitive to loss is adopted to choose the most effective weak feature of a human face so as to form a strong classifier at each stage in a multi-stage classifier structure; by this way, human face data and non-human-face data are separated. Since the strong classifier at each stage can reduce false acceptance rate of non-human-face data as much as possible on a condition of ensuring detection rate, the final classifier structure can realize high-performance human face detection in the complicated background image only in a case of having a simple structure. Here it should be noted that “weak feature” is a well-known concept in the art. However, one major drawback of this patent is that the method is able to be applied only to specific object detection within a certain range of angles, i.e., frontal view human face detection is mainly carried out; as a result, its application is limited in some measure.

Although a multi-stage classifier structure formed of plural classifiers used to detect angles can achieve multi-view detection in theory, a normal multi-stage classifier structure used to carry out multi-view detection cannot overcome the following two major problems: (1) as the number of the classifiers increases, detection time of the normal multi-stage classifier structure is increased, and then detection speed of the whole detection system becomes slow; as a result, it may be hard or even impossible to achieve real time detection, and (2) it may be hard or even impossible to reach detection accuracy equal to that of single-view object detection carried out under a certain angle; in other words, detection accuracy of the normal multi-stage classifier structure is low.

### SUMMARY OF THE INVENTION

The present invention is proposed for overcoming the disadvantages of the prior art. The present invention focuses on a key point of determining whether a window image is a specific object image in a specific object detection process so as to provide a multi-view specific object detection apparatus and a multi-view specific object detection method with regard to the key point. In embodiments of the present invention, by utilizing a multi-stage classifier structure formed of plural cascade classifiers, speed and accuracy of determining whether the window image is the specific object image are improved; by this way, the detection process is speeded up, and the detection accuracy is improved at the same time.

According to one aspect of the present invention, a multi-view specific object detection apparatus is provided. The multi-view specific object detection apparatus comprises an input device for inputting image data; and plural cascade classifiers in which each of the plural cascade classifiers is formed of plural stage classifiers corresponding to the same detection angle and corresponding to different features, and each of the plural stage classifiers is used to calculate degree of confidence of the image data for a specific object corresponding to the detection angle based on the aspect of the corresponding feature and used to determine whether the image data belongs to the specific object based on the degree of confidence. Between two stage classifiers in each of the plural cascade classifiers, a self-adaptive posture prediction device is disposed to determine, based on the degree of confidence calculated by the respective plural stage classifiers corresponding to the same detection angle and located before the self-adaptive posture prediction device, whether the image data enters the plural stage classifiers corresponding to the same detection angles and located after the self-adaptive posture prediction device.

According to another aspect of the present invention, a multi-view specific object detection method is provided. The multi-view specific object detection method comprises an inputting step of inputting image data; and plural parallel classification steps in which the plural parallel classification steps are sequentially formed of plural sub classification steps corresponding to the same detection angle and corresponding to different features, and each of the plural sub classification steps calculates degree of confidence of the image data for a specific object corresponding to the detection angle based on the aspect of the corresponding feature and determines whether the image data belongs to the specific object based on the degree of confidence. Between the sub classification steps in each of the plural parallel classification steps, a self-adaptive posture prediction step is executed for determining, based on the degree of confidence calculated by the plural sub classification steps corresponding to the same detection angles and located before the self-adaptive posture prediction step, whether the plural sub classification steps corresponding the same detection angles and located after the self-adaptive posture prediction step are executed with regard to the image data.

As a result, by adding the self-adaptive posture prediction process, some stage classifiers that are not related to the posture of the image data may be discarded at the earlier stages of the structure so that the determination speed is increased; at the same time, the self-adaptive posture prediction process can ensure that the stage classifiers related to the posture of the image data can be selected to carry out the follow-on determination, so that the determination accuracy is guaranteed. Therefore, according to the embodiments of the present invention, the determination speed of the specific object can be increased on a condition where the determination accuracy is not influenced. Here it should be noted that the posture generally refers to a rotation angle of a specific object with regard to a frontal view image in the art, for example, as shown in FIG. 3.

### BRIEF DESCRIPTION OF THE DRAWINGS

FIG. 1 illustrates a conventional multi-view specific object detection apparatus.

FIG. 2 illustrates a multi-view specific object detection apparatus according to an embodiment of the present invention.

FIGS. 3A and 3B illustrate rotation of an object with regard to a frontal view image; FIG. 3A illustrates a case of rotation in plane (RIP), and FIG. 3B illustrates a case of rotation off plane (ROP).

FIG. 4 illustrates how to extract window images from a whole image.

FIG. 5 illustrates a grouping effect of window images.

FIG. 6 is a block diagram of the structure of a self-adaptive posture prediction device according to an embodiment of the present invention.

FIGS. 7A and 7B illustrate how to choose at least one cascade classifier based on degree of belonging by using the self-adaptive posture prediction device.

FIG. 8 illustrates, in a case where a frontal view human face image is input, the number of the cascade classifiers at different stages, corresponding to different detection angles; here each of the cascade classifiers determines that the frontal view human face image is a non-human-face image.

FIG. 9 illustrates, in a case where a self-adaptive posture prediction device according to an embodiment of the present invention is adopted, influence on use of a stage classifier at the neighboring stage located after the self-adaptive posture prediction device caused by the self-adaptive posture prediction device.

FIG. 10 illustrates, in cases where a self-adaptive posture prediction device is adopted and is not adopted, comparison of distribution of the number of input images after determination by a stage classifier of a stage with regard to the maximum number of detection angles entering the next stage.

### DETAILED DESCRIPTION OF THE PREFERRED EMBODIMENTS

Hereinafter, embodiments of the present invention will be concretely described with reference to the drawings.

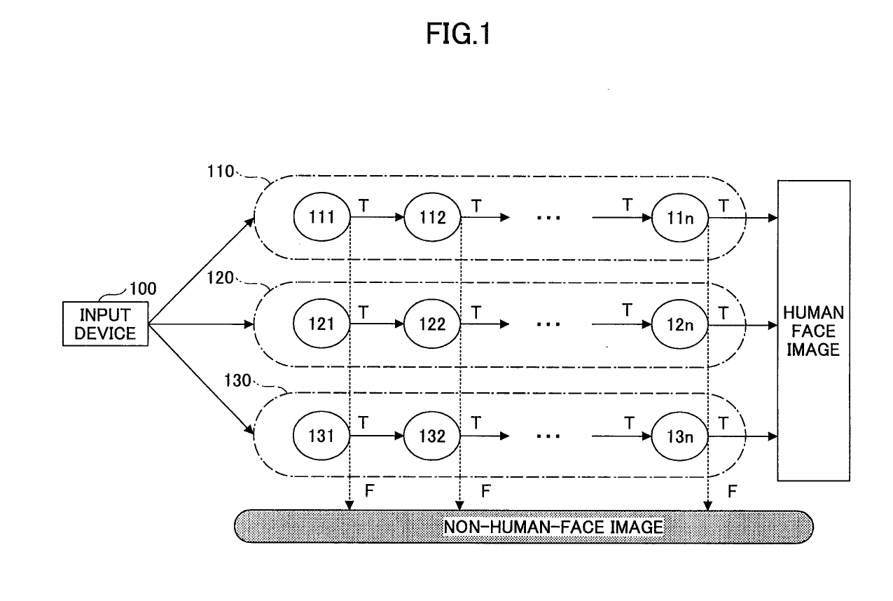

FIG. 1 illustrates a conventional multi-view specific object detection apparatus. In FIG. 1, an input device 100 is used for inputting image data; cascade classifiers 110, 120, and 130 correspond to different detection angles; the cascade classifier 110 is formed of stage classifiers 111, 112, . . . , and 11n; the cascade classifier 120 is formed of stage classifiers 121, 122, . . . , and 12n; the cascade classifier 130 is formed of stage classifiers 131, 132, . . . , and 13n; here n is a counting number. The second number from the left in a stage classifier symbol, for example, the second number 2 from the left in the stage classifier symbol 121, refers to the detection angle of the stage classifier. The third number from the left in a stage classifier symbol, for example, the third number 1 from the left in the stage classifier symbol 121, refers to the position of the stage classifier in the corresponding cascade classifier. That is, stage classifiers, whose symbols have the same third number from the left, in the cascade classifier can be considered being at the same stage; Here it should be noted that, in FIG. 1, although each of the cascade classifiers has n stage classifiers, those skilled in the art can understand that since features corresponding to different detection angles may be different, the numbers of the stage classifiers in the respective cascade classifiers may be different too; that is, the stage classifiers do not need to always form a matrix as shown in FIG. 1, or in other words, such kind of matrix is not always fully-filled with the stage classifiers.

Furthermore it should be noted that, in FIG. 1, although there are 3 cascade classifiers corresponding to 3 detection angles, it is apparent to those practiced in the art that the number of the cascade classifiers may be increased or decreased, for example, 2 cascade classifiers may be set up for 2 detection angles, 4 cascade classifiers may be set up for 4 detection angles, more cascade classifiers may be set up for more detection angles, or eventually only one cascade classifier may be set up for single-view detection as a special form of the multi-view specific object detection apparatus.

The input image data enters the cascade classifiers, respectively. First the stage classifier at the first stage in each of the cascade classifiers calculates degree of confidence of the image data for a specific object corresponding to the detection angle (i.e. the cascade classifier) based on the aspect of the corresponding feature, and then determines, based on the degree of confidence, whether the image data belongs to the specific object; here the specific object is, for example, a human face. If a stage classifier determines that the image data belongs to a non-human-face, the determination result is F (false), then the image data is classed in a non-human-face image group, and then the determination of the image data with regard to the corresponding detection angle ends; if a stage classifier determines that the image data belongs to a human face, the determination result is T (true), then the image data enters the next stage classifier corresponding to the detection angle to be determined. In this way, such kind of process goes to the last stage classifier in each of the cascade classifiers. For example, if the stage classifier at the n-th stage determines that the image data belongs to a human face, the determination result is T, and then the image data is classed in a human face image group.

Each of the stage classifiers may be any kind of strong classifier; for example, it is possible to adopt a known stage classifier in the algorithms of the Support Vector Machine (SVM), AdaBoost, etc. In each of strong classifiers, it is possible to use various weak features expressing local texture structures or a combination of them to make a calculation; the weak features are those usually adopted in the art, for example, HAAR features, multi-scale LBP features, etc.

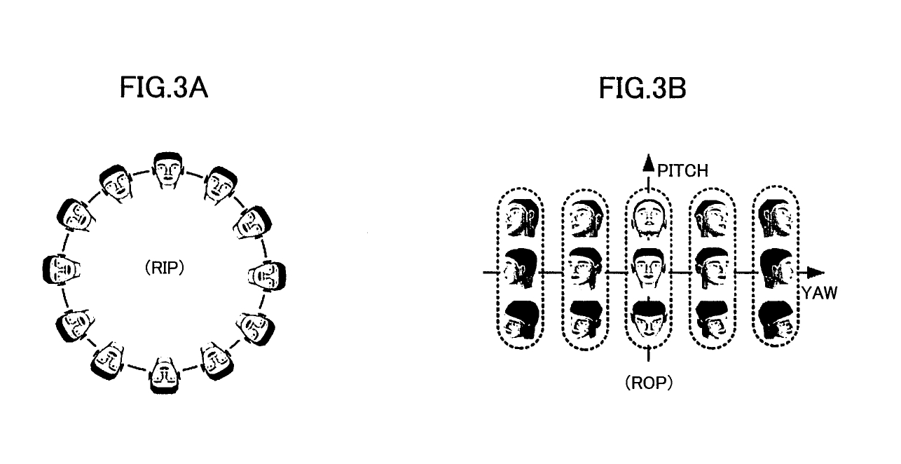

A stage classifier with regard to a specific object is obtained according to training regarding the property of the specific object carried out under a specific posture; here the posture generally refers to a rotation angle of the specific object with regard to a frontal view image in the art as shown in FIGS. 3A and 3B. FIGS. 3A and 3B illustrate the rotation of the specific object with regard to the frontal view image. FIG. 3A illustrates a case of rotation in plane (RIP); that is, the frontal view image at the top of the figure serves as a criterion, and the rotation is carried out with regard to the axis orthogonal to the image plane. FIG. 3B illustrates a case of rotation off plane (ROP); that is, the frontal view image at the center of the figure serves as a criterion, and the rotation is carried out along a pitch direction and a yaw direction, respectively. Here it should be noted that the frontal view image is a well-known concept in the art, and an image having a very small rotation angle with regard to the frontal view image is considered a frontal view image in practice too.

In the conventional technique shown in FIG. 1 and the below-mentioned embodiments of the present invention, a human face serves as a specific object prepared to be handled; however, both in the conventional technique and in the below-mentioned embodiments of the present invention, plural objects such as a human face, the palm of one's hand, a passerby, etc. can be handled too. No matter what object, what feature, and what detection angle, as long as they are specified before processing a task and training is conducted by adopting samples, the corresponding stage classifiers may be obtained to form the cascade classifier, and then, by carrying out training with regard to various detection angles, it is possible to obtain plural cascade classifiers able to carry out multi-view determination or multi-view detection.

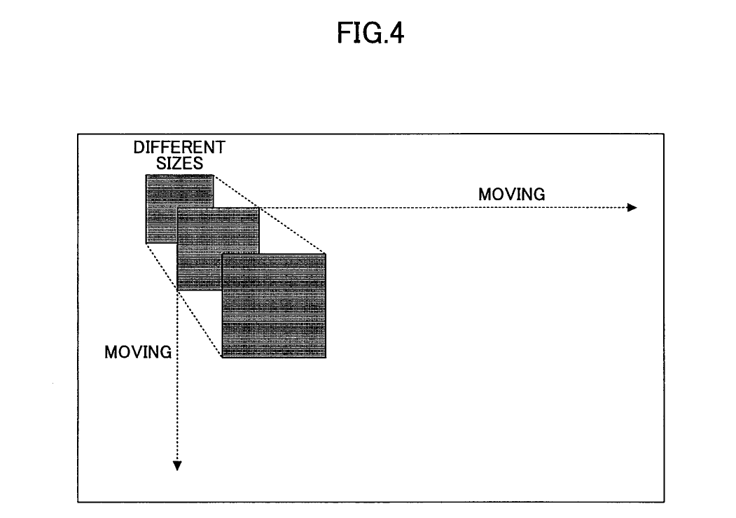

The multi-view specific object detection apparatus shown in FIG. 1 may be applied to, for example, processing of various media data such as static images, video, etc., to detect specific objects therein. It is possible to carry out determination by adopting a window image extraction device to extract window images from a whole image, and then output the window image data to the multi-view specific object detection apparatus as the image data prepared to be handled. FIG. 4 illustrates how to extract window images from the whole image; that is, it is possible to obtain a series of window images by moving windows having different sizes on the whole image according to different step lengths. Here it should be noted that both a window image extracted from a whole image and eventually a whole image from which a window image is not extracted may be handled by the multi-view specific object detection apparatus in the same way.

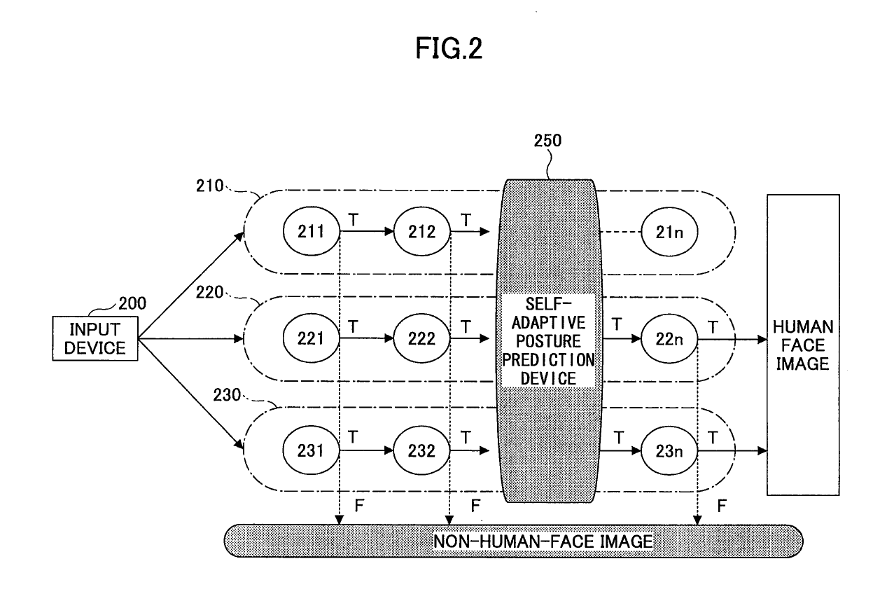

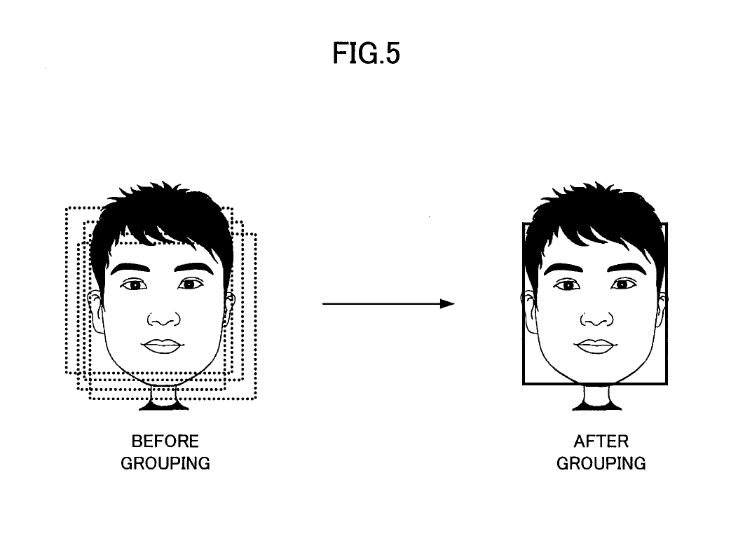

The result output by the multi-view specific object detection apparatus is a determination result of whether the input image data belongs to the specific object, or in other words, whether the input image data is the image data of the specific object. The input image data whose determination result is T (true) is output as the detection result of the specific object. If there are plural windows images, there may be plural detection results. However it is possible to adopt a grouping device to group plural window images, each of whose determination result is T (true), actually belonging to the same specific object in the original whole image into one image, so that one specific object has only one detection result. FIG. 5 illustrates a grouping effect of the window images. In FIG. 5, plural window images presented as dot-line frames before grouping are grouped into one window image presented as a solid-line frame. Such kind of group processing may be carried out by any conventional technique in the art, for example, the K-means method, etc. FIG. 2 illustrates a multi-view specific object detection apparatus according to an embodiment of the present invention. The multi-view specific object detection apparatus according to the embodiment of the present invention comprises an input device 200 used for inputting image data; plural cascade classifiers 210, 220, and 230 in which each of the plural cascade classifiers is formed of plural stage classifiers corresponding to the same detection angle and corresponding to different features, each of the plural stage classifiers is used for calculating degree of confidence of the image data to a specific object corresponding to the detection angle based on the aspect of the corresponding feature, and determining, based on the degree of confidence, whether the image data belongs to the specific object; and a self-adaptive posture prediction device 250, which is disposed between two of the plural stage classifiers of each of the cascade classifiers, used for determining, based on the degree of confidence calculated by the plural stage classifiers corresponding to the same detection angle and located before the self-adaptive posture prediction device 250, whether the image data enters the plural stage classifiers corresponding to the same detection angle and located after the self-adaptive posture prediction device 250.

The cascade classifiers 210, 220, and 230 correspond to different detection angles; the cascade classifier 210 is formed of stage classifiers 211, 221, . . . , 21n; the cascade classifier 220 is formed of stage classifiers 221, 222, . . . , 22n; the cascade classifier 230 is formed of stage classifiers 231, 232, . . . , 23n; here n is a counting number. The second number from the left in a stage classifier symbol, for example, the second number 2 from the left in the stage classifier symbol 221, refers to the detection angle of the stage classifier. The third number from the left in a stage classifier symbol, for example, the third number 1 from the left in the stage classifier symbol 221, refers to the position of the stage classifier in the corresponding cascade classifier. That is, stage classifiers, whose symbols have the same third number from the left, in the cascade classifiers can be considered being at the same stage; here it should be noted that, like the conventional multi-view specific object detection apparatus shown in FIG. 1, although there are n stage classifiers in each of the cascade classifiers in the multi-view specific object detection apparatus shown in FIG. 2 according to the embodiment of the present invention, those practiced in the art can understand that since features adopted by different detection angles may be different, the numbers of the stage classifiers in the respective cascade classifiers may be different too.

Furthermore it should be noted that, in FIG. 2, although there are 3 cascade classifiers corresponding to 3 detection angles, it is apparent to those skilled in the art that the number of the cascade classifiers may be increased or decreased, for example, 2 cascade classifiers may be set up for 2 detection angles, 4 cascade classifiers may be set up for 4 detection angles, more cascade classifiers may be set up for more detection angles, or eventually only one cascade classifier may be set up for single-view detection as a special form of the multi-view specific object detection apparatus.

Like the conventional multi-view specific object detection apparatus shown in FIG. 1, the multi-view specific object detection apparatus according to the embodiment of the present invention can not only handle a whole image but also handle a window image extracted by a window image extraction device from the whole image. As for these two kinds of the images, the multi-view specific object detection apparatus according to the embodiment of the present invention may handle them in the same way. Furthermore, like the conventional multi-view specific object detection apparatus shown in FIG. 1, a result output by the multi-view specific object detection apparatus according to the embodiment of the present invention is a determination result of whether the input image data belongs to the specific object, or in other words, whether the input image data is the image data of the specific object. The image data whose determination result is T (true) is output as the detection result of the specific object detection. If there are plural window images, there may be plural detection results. However, it is also possible to adopt a grouping device to group plural window images, each of whose determination result is T (true), actually belonging to the same specific object in the original whole image into one image, so that one specific object has only one detection result.

By comparing the multi-view specific object detection apparatuses shown in FIG. 1 and FIG. 2, it may be understood, based on the above illustration, that the same members in the multi-view specific object detection apparatus according to the embodiment of the present invention and the conventional multi-view specific object detection apparatus have the same functions, respectively, and each cascade classifier may adopt a strong classifier that can handle, after receiving the corresponding training, various specific objects such as a human face, the palm of one's hand, a passerby, etc. One difference between the multi-view specific object detection apparatus and the conventional multi-view specific object detection apparatus is that the self-adaptive posture prediction device 250 is disposed between two of the stage classifiers of each cascade classifier; by discarding the images of some stage classifiers which are not related to the posture of the image data, a great deal of detection time is saved, and by keeping the cascade classifiers with the similar detection angle as the input data in the follow-on determination, the detection accuracy is ensured. In the example shown in FIG. 2, a stage classifier located after the stage classifier 212 in the cascade classifier 210, for example, the stage classifier 21n, has its image discarded in the follow-on determination because the self-adaptive posture prediction device 250 determines that the difference between the detection angle of the stage classifier 21n and the posture of the input image data is relatively big; however, the remaining stage classifiers whose detection angles are close to the posture of the image data, for example, the stage classifiers in the cascade classifier sets 220 and 230, are used in the follow-on determination. It is apparent that, according to an actual environment, stage classifiers corresponding to other angles may be discarded depending on the input image data. Furthermore it should be noted that the self-adaptive posture prediction device 250 is used for choosing the cascade classifiers whose detection angles are close to the posture of the object in the input image data, not for directly determining whether the input image data belongs to the specific object serving as the detection object. Since the input image determined as a non-specific object image by the stage classifier located before the self-adaptive posture prediction device 250 is not handled anymore, this kind of the input image cannot enter the self-adaptive posture prediction device 250; as a result, the input image entering the self-adaptive posture prediction device 250 and prepared to be handled by the self-adaptive posture prediction device 250 may be considered being the specific object image.

In each cascade classifier, the stage classifiers may be arranged in ascending order of feature complexity. That is, the feature calculated by a stage classifier at the earlier stage is relatively simple, and the calculation complexity is relatively low; the later the stage is, the more complicated the feature calculated by the stage classifier is, and the higher the calculation complexity is. However, it can be understood by those trained in the art that, in a cascade classifier, the arrangement of the stage classifiers may also be carried out in any other order, may not be related to the features at all, or may be related to the features. The self-adaptive posture prediction device 250 may be disposed at any position inside the respective cascade classifiers; for example, it may be disposed between the first stage and the second stage, or between the second stage and the third stage. It can be understood by those educated in the art that the self-adaptive posture prediction device 250 disposed between two other stage classifiers may also realize the goal of discarding the images of the stage classifiers which are not related to the input image data so as to save the detection time and improve the determination accuracy.

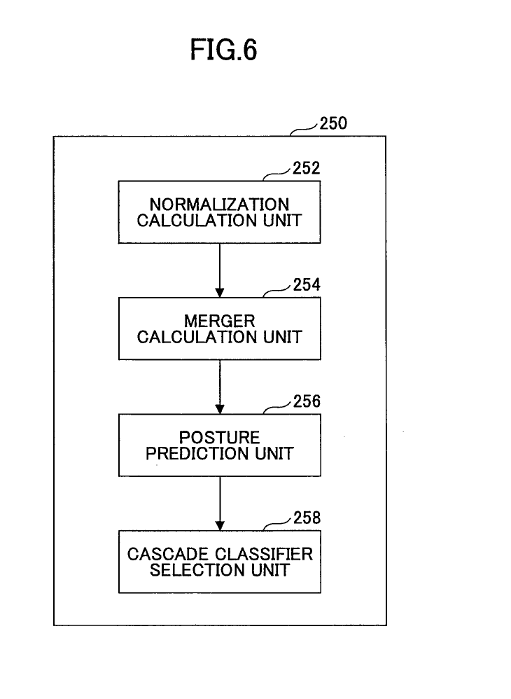

FIG. 6 illustrates the structure of the self-adaptive posture prediction device 250. The self-adaptive posture prediction device 250 comprises a normalization calculation unit 252 used for normalizing the degree of confidence calculated by the stage classifiers corresponding to the same detection angle and located before the self-adaptive posture prediction device so as to obtain a degree-of-confidence normalization value; a merger calculation unit 254 used for merging the degree-of-confidence normalization values obtained by the normalization calculation unit 252 so as to obtain a merged value corresponding to the detection angle; a posture prediction device 256 used for calculating, based on the merged value corresponding to the detection angle obtained by the merger calculation unit 254, a degree of belonging of the input image data to the corresponding detection angle; and a cascade classifier selection unit 258 used for comparing the degree of belonging corresponding to the detection angle and a predetermined threshold value so as to select a stage classifier whose degree-of-belonging value is greater than the predetermined threshold value, corresponding to the detection value and located after the self-adaptive posture prediction device 250 for letting the image data enter therein.

Since the self-adaptive posture prediction device 250 is located between the stage classifiers at the same stage in each of the cascade classifiers, the self-adaptive posture prediction device 250 and its units i.e. the normalization calculation unit 252, the merger calculation unit 254, the posture prediction unit 256, and the cascade classifier selection unit 258 carry out the prediction with regard to the determination result before the stage; that is, the operation of the self-adaptive posture prediction device 250 and its units is carried out with regard to the stage classifiers before the stage in each of the cascade classifiers.

The task of the normalization calculation unit 252 is normalizing the output data by the strong classifiers at each stage in each cascade classifier located before the self-adaptive posture prediction device 250 into the same measurement space. It is supposed that, in the i-th cascade classifier currently being handled, there are m stages before the self-adaptive posture prediction device 250, the stage classifier of the j-th stage in the i-th cascade classifier is currently being handled (here m is a counting number; i and j are positive integer indexes), and the degree of confidence, calculated by this stage classifier, of the image data of the specific object corresponding to the detection angle based on the aspect of the corresponding feature is val_{i,j}. The normalization calculation unit 252 may adopt various conventional normalization methods, for example, the Min-Max method, the Z-Score method, the MAD method, the Double-Sigmoid method, the Tanh-Estimator method, etc.

For example, in a case where the Min-Max method is adopted, the normalization value nval_{i,j} of the stage classifier at the j-th stage in the i-th cascade classifier can be calculated by the following equation (1).

nval_{i,j}=(val_{i,j}−valₘᵢₙ)/(valₘₐₓ−valₘᵢₙ) (1)

Here valₘₐₓ and valₘᵢₙ is a value obtained by the stage classifier in a training process, respectively. In particular, valₘₐₓ refers to the maximum value among the degrees of confidence obtained in the training process carried out with regard to the feature adopted by the j-th stage classifier of the detection angle corresponding to the i-th cascade classifier, i.e., the maximum value which can be acquired by this strong classifier with regard to all the input sample data; valₘᵢₙ refers to the minimum value among the degrees of confidence obtained in the training process carried out by the stage classifier, i.e., the minimum value which can be acquired by this strong classifier with regard to all the input sample data.

In a case where a non-human-face sample image is adopted in training, since the variation range of the degrees of confidence calculated with regard to the non-human-face is relatively wide, noise data is easily introduced when measuring data; as a result, the accuracy of the normalization result is influenced. The classified result i.e. the degree of confidence calculated by the stage classifier with regard to the non-human-face sample generally is a negative value, whereas the degree of confidence calculated with regard to the human face sample generally is a positive value. In order to solve this problem, it is possible to directly let the value of valₘᵢₙ in the equation (1) be zero so that the influence on the normalization caused by the noise data departing from an accurate data distribution can be removed. By improving the equation (1) in this way, the following equation (2) i.e. the normalization equation can be obtained.

nval_{i,j}=(val_{i,j}−0)/(valₘₐₓ−0) (2)

The normalization calculation unit 252 may also adopt, for example, the Z-Score method; in this case, the normalization value nval_{i,j} of the stage classifier at the j-th stage in the i-th cascade classifier can be calculated by the following equation (3)

nval_{i,j}=(val_{i,j}−μ)/σ (3)

Here μ and σ are the average value and the mean square error of the values obtained in a training process carried out with regard to the feature adopted by j-th stage classifier of the detection angle corresponding to the i-th cascade classifier, respectively.

The merger calculation unit 254 is used for merging data. It can merge the calculation results of the strong classifiers at all the stages located before the self-adaptive posture prediction device 250, of the respective cascade classifiers so as to acquire a merger value with regard to each cascade classifier. The merger calculation unit 254 may adopt various data-based merger methods, for examples, the sum method, the product method, the MAX method, etc.

For example, when the merger calculation unit 254 adopts the sum method to merge the output data of the strong classifiers at preceding stages, it is possible not only to utilize historic information at the preceding stages of each cascade classifier efficiently but also to further increase the robustness of merger. In this circumstance, the merger value snvalᵢ can be calculated based on the degree-of-confidence normalization value nval_{i,j} of the stage classifiers at m stages before the normalization calculation unit 252, in the i-th cascade classifier by using the following equation (4).

snvalᵢ=Σnval_{i,j} (4)

Alternatively, except the sum method, the merger calculation unit 254 may also adopt, for example, the product method, to merge the output data of the stage classifiers at the preceding stages, and then the merger value snvalᵢ can be calculated based on the degree-of-confidence normalization value nval_{i,j} of the stage classifiers at m stages before the normalization calculation unit 252, in the i-th cascade classifier by using the following equation (5).

snvalᵢ=Πnval_{i,j} (5)

The posture prediction unit 256 may self-adaptively predict the most proper posture of the specific object based on the merger result obtained by the merger calculation unit 254; here the most proper posture of the specific object is the actual angle of the specific object in the handled image data. Then degree of belonging of the image data to the corresponding detection angle is calculated based on the relationship of the angle of the specific object in the image data and the corresponding detection angle. The self-adaptivity is presented as follows: the adopted calculation formula may self-adaptively make a posture prediction based on the data distribution of the stage classifiers at the preceding stages.

For example, the posture prediction unit 256 may utilize the following self-adaptive equation (6) to calculate the degree of belonging ratio, of the image data to the detection angle corresponding to the i-th cascade classifier based on the degree-of-confidence merger value snvalᵢ of the preceding m stage classifiers in the i-th cascade classifier calculated by the merger calculation unit 254 and the maximum value snvalₘₐₓ of the degree-of-confidence merger values of the preceding m stage classifiers in the cascade classifiers corresponding to all the detection angles which are covered by the self-adaptive posture prediction device 250.

ratioᵢ=abs(snvalᵢ−snvalₘₐₓ)/snvalᵢ (6)

Here abs refers to the calculation of absolute value.

Alternatively the posture prediction unit 256 may also utilize the following self-adaptive equation (7) to calculate the degree of belonging ratio, of the image data to the detection angle corresponding to the i-th cascade classifier based on the degree-of-confidence merger value snvalᵢ of the preceding m stage classifiers in the i-th cascade classifier calculated by the merger calculation unit 254 and the maximum value snvalₘₐₓ of degree-of-confidence merger values of the preceding m stage classifiers in the cascade classifiers corresponding to all the detection angles which are covered by the self-adaptive posture prediction device 250.

ratioᵢ=snvalᵢ/snvalₘₐₓ (7)

The cascade classifier selection unit 258 is used to choose the most proper one or plural detection angles from the plural detection angles for being employed in the object recognition determination at the follow-on stages; that is, if the degree of belonging of the angle of the specific object in the image data with regard to a detection angle is too low, the stage classifier of this detection angle is not utilized anymore in the determination at the follow-on stages.

In the process of choosing the stage classifier of each of the detection angles, a predetermine threshold value thr is employed to determine whether the degree of belonging calculated by the posture prediction unit 256 for each of the detection angles can pass through the cascade classifier selection unit 258. For example, in a case where the following equation (8) is used to determine whether the i-th cascade classifier is selected, if ratio, is greater than or equal to the predetermined threshold value thr, then the selection result res is 1 that means that the stage classifiers in the i-th cascade classifier after the self-adaptive posture prediction device 250 are continuously adopted; if ratio, is less than the predetermined threshold value thr, then the selection result res is 0 that means that the stage classifiers in the i-th cascade classifier after the self-adaptive posture prediction device 250 are not adopted anymore.

$$res = \{ \begin{matrix}1 , & if {ratio}_{i} \geq thr \\ 0 , & if {ratio}_{i} < thr\end{matrix} \qquad ( 8 )$$

It is apparent that those skilled in the art can understand that the above-mentioned criteria may be rewritten as follows: if ratio, is greater than the predetermined threshold value thr, then the selection result res is 1; if ratioᵢ is less than or equal to the predetermined threshold value thr, then the selection result res is 0.

Here the predetermined threshold value thr may be obtained by adopting a certain amount of sample data to carry out training; it may be determined as follows: when carrying out the training, as for the most positive samples in the sample data, it is necessary to ensure that the above-mentioned degrees of belonging calculated by the above-mentioned calculation are greater than the predetermined threshold value. For example, it is necessary to ensure that 95% of the human face samples can be determined as human face data. However, it is apparent that those practiced in the art can understand that the predetermined threshold value thr may also be obtained by ensuring that 80%, 90%, etc. of the human face samples can be determined as human face data.

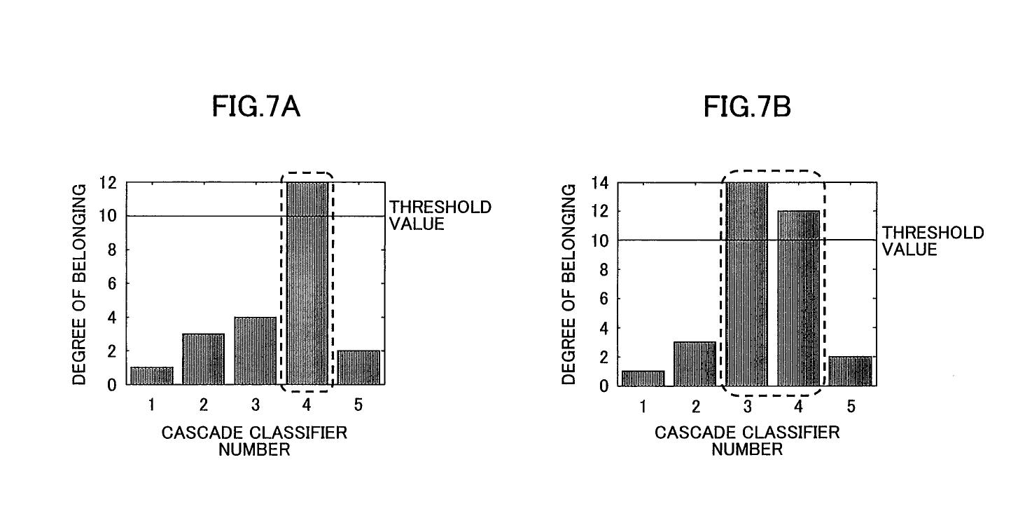

FIGS. 7A and 7B illustrate an example that the self-adaptive posture prediction device 250 chooses at least one cascade classifier based on the degree of belonging, respectively. In each of the examples shown in FIGS. 7A and 7B, 5 cascade classifiers corresponding to 5 detection angles are adopted, each cascade classifier corresponds to a column in the figure, the column height refers to the degree of belonging of the corresponding cascade classifier calculated by the above-mentioned calculation, and the column(s) surrounded by the dotted line means that its (or their) corresponding detection angle(s) is (or are) selected. In the example shown in FIG. 7(A), the degree of belonging of the 4-th cascade classifier is obviously higher than those of the other detection angles, i.e., only the degree of belonging of the 4-th cascade classifier may be greater than the predetermined threshold value; as a result, only this detection angle is selected for passing the determination. In the example shown in FIG. 7(B), the degrees of belonging of the 3rd and 4th cascade classifiers may be greater than the predetermined threshold value, respectively; as a result, these two detection angles are selected for passing the determination.

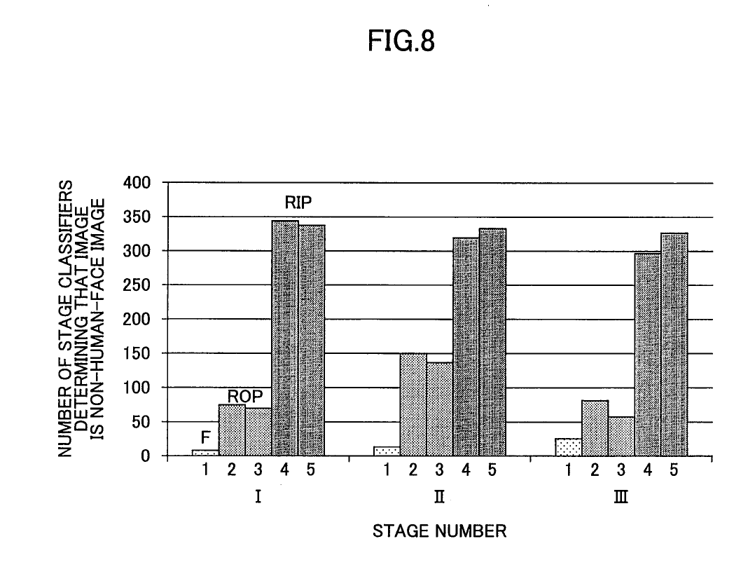

FIG. 8 illustrates examples of the numbers of stage classifiers at different stages of different detection angles in a case where image data of a frontal view human face is input (totally 500 frontal faces are input); here the stage classifiers determine that the image data of the frontal view human face is non-human-face data, respectively. In FIG. 8, numbers I, II, and III refer to the first stage, the second stage, and the third stage, respectively; the numbers 1, 2, 3, 4, and 5 refer to 5 detection angles, respectively. Here 1 corresponds to the detection angle of frontal view F, 2 and 3 correspond to two detection angles of rotation off plane (ROP), 4 and 5 correspond to two detection angles of rotation in plane (RIP), and the height of each of the columns refers to the number of the stage classifiers by which the image data of the frontal view human face is determined as the non-human-face data in a case where the image data of the frontal view human face is input. It should be noted that, in the experiment with regard to FIG. 8, the self-adaptive posture prediction device 250 is not adopted. In a case where the image data of the frontal view human face is input, in each of the stages, the number of cases in which the image data of the frontal view human face is determined as the non-human-face data by the stage classifiers whose detection angles are the RIP angle is relatively large, whereas the number of cases in which the image data of the frontal view human face is determined as the non-human-face data by the stage classifiers whose detection angles are the ROP angle is obviously decreasing, i.e., almost all may pass through the stage classifiers whose detection angles are the frontal view. This indicates that there is a certain overlap zone among the postures which may be detected by the stage classifiers having different detection angles. And also this is the reason why it is possible to choose plural cascade classifiers of different detection angles as shown in FIG. 7B by using the self-adaptive posture prediction device 250 according to the embodiment of the present invention.

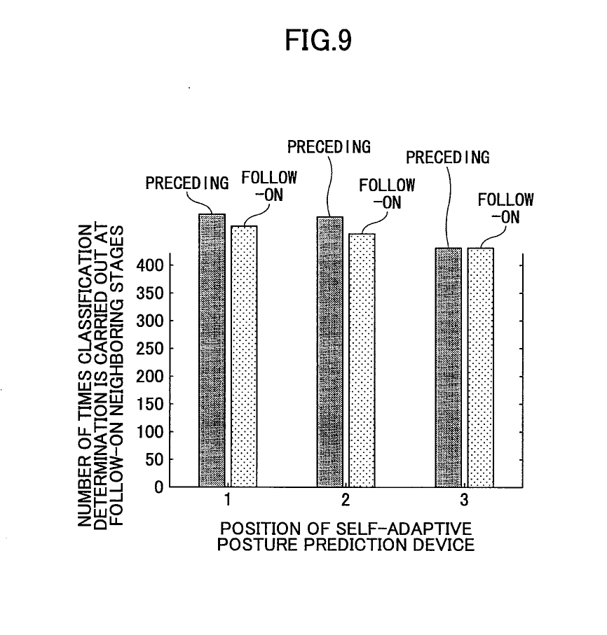

FIG. 9 illustrates an example of the influence on use of the stage classifiers at the follow-on neighboring stage in a case where the self-adaptive posture prediction device 250 according to the embodiment of the present invention is adopted. In FIG. 9, the numbers 1, 2, and 3 means that the insert position of the self-adaptive posture prediction device in three experiments is located between the first stage and the second stage, the second stage and the third stage, and the third stage and the fourth stage, respectively. FIG. 9 is a case of a cascade classifier whose detection angle is the frontal view, and the input is also 500 images of the frontal human face. Two columns corresponding to the insert positions refer to a ratio of the number of times the classification determination is carried out in the adjacent corresponding stages (i.e. those corresponding to the second, third, and fourth stage from the left to the right) located after the self-adaptive posture prediction device to the number of times the classification determination is carried out in these stages without the self-adaptive posture prediction device 250; the left one of the two columns corresponding to each of the insert positions refers to a case without the self-adaptive posture prediction device 250, and the right one refers to a case of having the self-adaptive posture prediction device 250. FIG. 9 indicates that the classification determinations needing to be carried out at the corresponding stages before adding the self-adaptive posture prediction device are almost all reserved at these stages after adding the self-adaptive posture prediction device. In other words, in a case where the self-adaptive posture prediction device is added, the stage classifiers which should be adopted are almost all reserved for carrying out the classification determinations; that is, there are very few cases where the stage classifiers are wrongly discarded. The reason why the stage classifiers are wrongly discarded is that there may be a minimum angle between a sample image of a frontal view human face in practice and that of an ideal frontal view; as a result, stage classifiers may be determined as belonging to the other angle by the self-adaptive posture prediction device 250. However, it is possible for this kind of image to be determined by using the cascade classifier corresponding to the other angle in practice. In other words, in a case where the self-adaptive posture prediction device 250 is added so that a cascade classifier of a certain detection angle is discarded, the detection accuracy is not influenced.

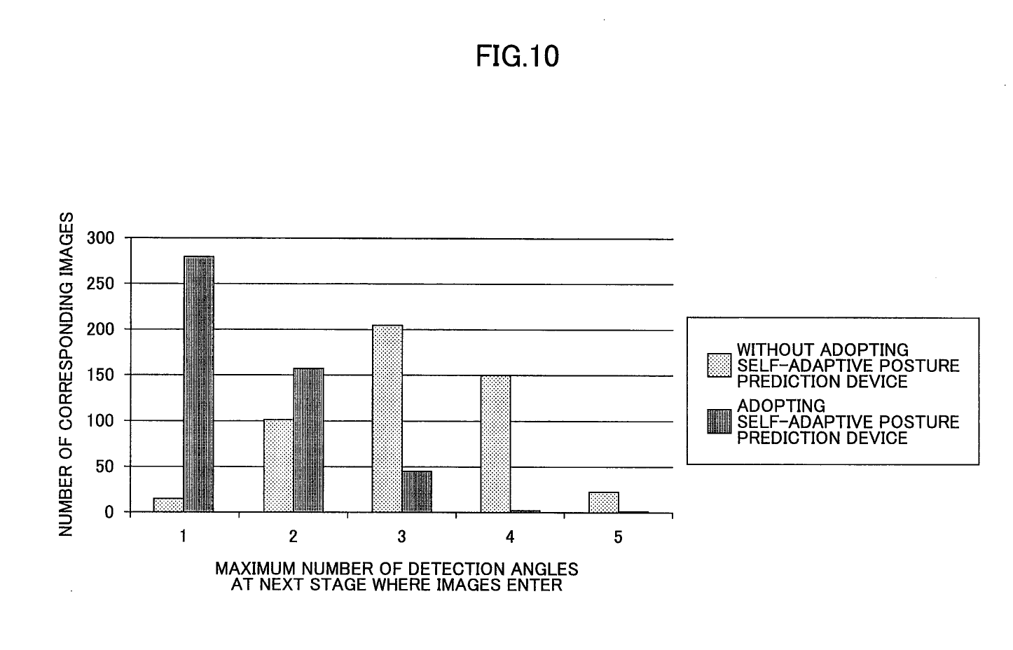

FIG. 10 illustrates, in cases where the self-adaptive posture prediction device 250 is adopted and is not adopted, an example of distribution comparison of the number of input images after having been determined by a stage classifier at a stage with regard to the maximum number of detection angles entering the next stage. In the experiment related to FIG. 10, the self-adaptive posture prediction device 250 is added between the second stage and the third stage. In FIG. 10, the abscissa axis means the maximum number of detection angles at the third stage where the input image data after having been determined by the stage classifiers at the second stage enter; the numbers 1, 2, 3, 4, and 5 stand for the maximum numbers 1, 2, 3, 4, and 5 of the detection angles at the third stage where the input image data enter, respectively; and the two columns corresponding to the numbers of the detection angles stand for the maximum numbers of the input images entering the stage classifiers of the detection angle having the corresponding number in a case where the self-adaptive posture prediction device 250 is not adopted and in a case where the self-adaptive posture prediction device 250 is adopted, respectively.

According to FIG. 10, it is apparent that, in the conventional multi-view specific object detection apparatus without adopting the self-adaptive posture prediction device 250 as shown in FIG. 1, most input images may enter the stage classifiers of 3 or 4 detection angles at the third stage, whereas in the multi-view specific object detection apparatus adopting the self-adaptive posture prediction device 250 as shown in FIG. 2, most input images may only enter the stage classifiers of 1 or 2 detection angles at the third stage, particularly a large amount of input images may only enter the stage classifiers of one detection angle at the third stage. As a result, the calculation amount at the follow-on stages may be decreased, and then the detection speed may be improved. In particular, in a case where the successive cascade classifiers are set up by gradually increasing the calculation complexity of features with the increase of the stage, this performance is more obvious.

In the experiment with regard to FIG. 10, 5 cascade classifiers and 500 input images are adopted, and as for each of the input images, there are 5 stage classifiers at the first stage; therefore, in the initial stage, the calculation amount is based on the 2500 classifiers. However, after the third stage, in a case without adopting the self-adaptive posture prediction device 250, the calculation amount at all the remaining stages is based on 1749 stage classifiers, whereas in a case of adopting the self-adaptive posture prediction device 250, the calculation amount at all the remaining stages is based on 1082 stage classifiers. In other words, in the calculation at the follow-on stages, 40% of calculation time is omitted due to adding the self-adaptive posture prediction device 250; as a result, the detection speed is increased.

Furthermore a multi-view specific object detection method is provided too. The multi-view specific object detection method comprises an input step executed by the input device 200, of inputting image data; plural parallel classification steps executed by the plural cascade classifiers, respectively, wherein, each of the plural classification steps is sequentially formed of plural sub classification steps corresponding to the same detection angle, each of the sub classification steps executed by each of the stage classifiers, different sub classification steps correspond to different features, and in each of the sub classification steps, a degree of confidence of the image data of a specific object corresponding to the detection angle based on the aspect of the corresponding feature is calculated and whether the image data belongs to the specific object is determined based on the degree of confidence; and a self-adaptive posture prediction step between the sub classification steps of each of the plural classification steps, executed by the self-adaptive posture prediction device 250, wherein, based on the degree of confidence calculated in each of the sub classification steps corresponding to the same detection angle and located before the self-adaptive posture prediction step, whether each of the sub classification steps corresponding to the detection angle, located after the self-adaptive posture prediction step is carried out with regard to the image data is determined.

The self-adaptive posture prediction step comprises a normalization calculation step executed by the normalization calculation unit 252, of normalizing the degree of confidence calculated in each of the sub classification steps corresponding to the same detection angle and located before the self-adaptive posture prediction step so as to obtain a degree-of-confidence normalization value; a merger calculation step executed by the merger calculation unit 254, of merging the degree-of-confidence normalization values corresponding the detection angle obtained in the normalization calculation step so as to obtain a merger value corresponding to the detection value; a posture prediction step executed by posture prediction unit 256, of calculating a degree of belonging of the image data of each of the detection angles based on the merger values obtained in the merger calculation step; and a classification step selection step executed by the cascade classifier selection unit 258, of selecting, by comparing the degree of belonging corresponding to the detection angles and a predetermined threshold value, the sub classification steps corresponding to at least one detection angle whose degree of belonging is greater than the predetermined threshold value and located after the self-adaptive posture prediction step to handle the image data.

Each of the classification steps comprises a sub classification arrangement step of arranging the sub classification steps in ascending order of feature complexity. The sub classification steps, whose positions in the arranged results obtained in the sub classification arrangement step are the same, belong to the same stage. The self-adaptive posture prediction step is executed between the first stage and the second stage or between the second stage and the third stage.

A series of operations described in this specification can be executed by hardware, software, or a combination of hardware and software. When the operations are executed by software, a computer program can be installed in a dedicated built-in storage device of a computer so that the computer can execute the computer program. Alternatively the computer program can be installed in a common computer by which various types of processes can be executed so that the common computer can execute the computer program.

For example, the computer program may be stored in a recording medium such as a hard disk or a read-only memory (ROM) in advance. Alternatively the computer program may be temporarily or permanently stored (or recorded) in a movable recording medium such as a floppy disk, a CD-ROM, a MO disk, a DVD, a magic disk, or a semiconductor storage device.

While the present invention is described with reference to the specific embodiments chosen for purpose of illustration, it should be apparent that the present invention is not limited to these embodiments, but numerous modifications could be made thereto by those skilled in the art without departing from the basic concept and scope of the present invention.

The present application is based on Chinese Priority Patent Application No. 201010108579.5 filed on Feb. 8, 2010, the entire contents of which are hereby incorporated by reference.

What is claimed is:

1. A multi-view specific object detection apparatus comprising:
an input device used to input image data; and
plural cascade classifiers, wherein,
each of the plural cascade classifiers is formed of plural stage classifiers corresponding to a same detection angle,
the plural stage classifiers correspond to different features, and
each of the plural stage classifiers is used to calculate a degree of confidence of the image data of a specific object corresponding to the detection angle based on the aspect of the corresponding feature, and determine whether the image data belongs to the specific object based on the degree of confidence,
wherein,
a self-adaptive posture prediction device is disposed between two stage classifiers in each of the plural cascade classifiers, and used to determine, based on the degree of confidence calculated by the plural stage classifiers corresponding to the detection angles and located before the self-adaptive posture prediction device, whether the image data enters the plural stage classifiers corresponding to the detection angles and located after the self-adaptive posture prediction device.

2. The multi-view specific object detection apparatus according to claim 1, wherein, the self-adaptive posture prediction device comprises:
a normalization calculation unit used to normalize the degree of confidence calculated by each of the plural cascade classifiers corresponding to the detection angle and located before the self-adaptive posture prediction device so as to obtain a degree-of-confidence normalization value;
a merger calculation unit used to merge the degree-of-confidence normalization values obtained by the normalization calculation unit so as to acquire a merger value corresponding to the detection value;
a posture prediction unit used to calculate a degree of belonging of the image data to the detection angles based on the merger value corresponding to the detection values; and
a cascade classifier selection unit used to select, by comparing the degree of belonging corresponding to the detection angles and a predetermined threshold value, the plural stage classifiers corresponding to at least one detection angle whose degree of belonging is greater than the predetermined threshold value and located after the self-adaptive posture prediction device for letting the image data enter therein.

3. The multi-view specific object detection apparatus according to claim 1, wherein:
in each of the plural cascade classifiers, the plural stage classifiers are arranged in ascending order of feature complexity.

4. The multi-view specific object detection apparatus according to claim 3, wherein:
the stage classifiers, whose positions in the arranged plural cascade classifiers are the same, belong to the same stage; and
the self-adaptive posture prediction device is located between the first stage and the second stage or between the second stage and the third stage.

5. The multi-view specific object detection apparatus according to claim 1, wherein:
the specific object is a human face.

6. The multi-view specific object detection apparatus according to claim 1, wherein:
the stage classifier is a strong classifier.

7. A multi-view specific object detection method comprising:
an input step of inputting image data; and
plural parallel classification steps, wherein,
each of the plural parallel classification steps is sequentially formed of plural sub classification steps corresponding to a same detection angle,
the plural sub classification steps correspond to different features, and
in each of the plural sub classification steps, a degree of confidence of the image data of a specific object of the corresponding detection angle based on the aspect of the corresponding feature is calculated, and whether the image data belongs to the specific object is determined based on the degree of confidence,
wherein,
a self-adaptive posture prediction step is executed between two sub classification steps of each of the plural parallel classification steps for determining, based on the degree of confidence calculated in the sub classification steps corresponding to the detection angles and located before the self-adaptive posture prediction step, whether the sub classification steps corresponding to the detection angles and located after the self-adaptive posture prediction step are executed with regard to the image data.

8. The multi-view specific object detection method according to claim 7, wherein, then self-adaptive posture prediction step comprises:
a normalization calculation step of normalizing the degree of confidence calculated in each of the sub classification steps corresponding to the detection angle and located before the self-adaptive posture prediction step so as to obtain a degree-of-confidence normalization value;
a merger calculation step of merging the degree-of-confidence normalization values corresponding the detection angle obtained in the normalization calculation step so as to obtain a merger value corresponding to the detection value;
a posture prediction step of calculating a degree of belonging of the image data to the detection angles based on each of the merger values obtained in the merger calculation step; and
a classification step selection step of selecting, by comparing the degree of belonging corresponding to the detection angles and a predetermined threshold value, the sub classification steps corresponding to at least one detection angle whose degree of belonging is greater than the predetermined threshold value and located after the self-adaptive posture prediction step to handle the image data.

9. The multi-view specific object detection method according to claim 7, wherein:
in each of the plural parallel classification steps, the plural sub classification steps are arranged in ascending order of feature complexity.

10. The multi-view specific object detection method according to claim 9, wherein:
the sub classification steps whose positions in the arranged plural parallel classification steps are the same, belong to the same stage; and
the self-adaptive posture prediction step is executed between the first stage and the second stage or between the second stage and the third stage.
